(19) United States
(12) Patent Application Publication
(10) Pub. No.: US 2009/0022370 A1
(43) Pub. Date: Jan. 22, 2009

(54) Method and apparatus for detecting meaningful motion

(75) Inventors: Yong-seok Yoo, Seoul (KR); Tae-suh Park, Yongin-si (KR); Seok-cheol Kee, Uiwang-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/078,790

(22) Filed: Apr. 4, 2008

(30) Foreign Application Priority Data
Jul. 18, 2007 (KR) 10-2007-0071702

(51) Int. Cl. G06K 9/00

(52) U.S. Cl. 382/107

(57) ABSTRACT

A method and apparatus for detecting a meaningful motion. The method of detecting a meaningful motion includes generating a difference image including a plurality of regions each having a sign according to a motion of an input image from a plurality of input images, and by calculating the amount of motion in the difference image based on the sign of each of the regions of the difference image, detecting a meaningful motion of the input image. According to the method and apparatus, a high detection ratio can be maintained, while a false alarm ratio with regard to meaningless motion can be lowered.

### CROSS-REFERENCE TO RELATED APPLICATIONS

This application claims the benefit of Korean Patent Application No. 10-2007-0071702, filed on Jul. 18, 2007, in the Korean Intellectual Property Office, the disclosure of which is incorporated herein in its entirety by reference.

### BACKGROUND

1. Field

One or more embodiments of the present invention relates to a method and apparatus for detecting motion, and more particularly, to a method and apparatus for detecting only a meaningful motion in an input image, and an alarm apparatus, a frame output apparatus, an image compression apparatus, and an image processing apparatus using a detected meaningful motion.

2. Description of the Related Art

Recently, with the prevalence of crime and theft, demand for surveillance cameras has been rapidly increasing. As areas to be monitored are expanding and the number of cameras being used is increasing, it becomes impossible for a person to watch and monitor each and every image. Also, as the picture quality and resolution of image pickup apparatuses have improved and the size of images has increased, transmission or storage of images causes another problem.

In order to solve these problems, a conventional image monitoring apparatus should interpret the meaning of an image and respond differently according to circumstances, in addition to simply photographing an object area and transmitting and storing the images. The most important clue as to what is happening in an area of interest is motion. A variety of application examples for detecting the presence of a moving object in an object area and utilizing the result of the detection have been introduced. A first example is that when a motion is detected in an area being monitored, an alarm is generated to draw the attention of a guard. In another example, only when a motion is detected in an area, the image is transmitted or stored so that the efficiency of transmission and storage can be enhanced.

The performance of detecting a motion in an image is measured by a detection ratio and a false alarm ratio. The detection ratio is defined as a ratio of detecting the motion of an actual object without missing the motion. The higher the detection ratio, the better the detection performance. The false alarm ratio is defined as a ratio of taking what is not a motion of an actual object as a motion of the object. The lower the false alarm ratio, the better the detection performance. The problem lies in that there is a general tendency that if the detection ratio is raised, the false alarm ratio is raised together. Accordingly, current techniques accept a high-level false alarm ratio in order to raise the detection ratio. However, this ultimately causes an alarm to lose its function as an alarm. This is because an alarm is caused by a variety of factors such as illumination, weather, CCD noise and meaningless motion, thereby requesting guards to always concentrate their eyes on images. For example, according to a conventional technique, when a tree exists in an area to be monitored, if the tree is moved by wind, the movement is also detected as a motion of the object, thereby causing an alarm. Also, ripples of a lake or pond in a monitoring area are also detected as a motion according to conventional motion detection techniques. However, this motion is meaningless motion and alarms caused by this motion correspond to false alarms. Reducing this false alarm ratio has become one of the most important challenges.

FIG. 1 is a schematic block diagram illustrating a conventional motion detection apparatus. In the conventional motion detection apparatus illustrated in FIG. 1, a difference image between two continuous images from input moving pictures is obtained from the illustrated subtraction unit in cooperation with the illustrated delay unit, and if the absolute value of the difference of brightness values, as determined by the illustrated absolute value calculation unit, of the two images exceeds a predetermined threshold value, as determined by the illustrated comparison value unit, it is determined that the area has a motion and an alarm may be set by the illustrated alarm unit. However, this method of detecting a motion area by using a fixed threshold value from the difference image has a problem that according to the threshold value, the result varies greatly.

In order to solve this problem, Y. Z. Hsu and others suggested a technique for adjusting a threshold value with respect to the characteristic of an image in “New Likelihood test methods for change detection in image sequences”, Computer Vision, Graphics, and Image Processing, 1984. However, the threshold adjustment technique still has a problem that it is liable to miss an object which moves slowly.

In order to solve this problem, a method has been suggested by Tagami and others in International Publication No. WO 03/088648, “Motion detector, image processing system, motion detection method, program, and recording medium”. According to the method, even an area with a value lower than a threshold value can be determined as a moving area if the accumulated difference of the area is big enough between images in the area, thereby allowing even a gradual motion to be detected. Also, by detecting an area in which change is small, the threshold value is lowered for the area, thereby allowing even a small change to be detected as a motion area. However, this method of adjusting a threshold according to the characteristic of an image is liable to cause an error in which noise or illumination change is detected as motion because of the lowered threshold.

Thus, the techniques of detecting motion based on a difference image have advantages of simplicity to implement and high speed, but have a disadvantage of a high false alarm ratio.

Another technique of detecting motion is to use an optical flow. U.S. Pat. No. 6,303,920, entitled “Method and apparatus for detecting salient motion using optical flow” by L. Wixson et. al., and “Detecting Salient Motion by Accumulating Directionally Flow”, IEEE Transactions on PAMI 2000 disclose a technique of distinguishing a meaningful motion and a meaningless motion by using an optical flow. This technique assumes that a meaningful motion moves continuously in a predetermined direction, and detects an area having a continuous motion in a predetermined direction in an image.

The technique by Wixson is greatly influenced by the accuracy of an optical flow. However, in an actual image, an optical flow cannot be calculated accurately.

Also, an optical flow has high computation complexity, and therefore it is difficult to calculate in real-time. In addition, in a process of calculating an accumulated flow by connecting continuous optical flows, errors of the optical flows are accumulated. This badly affects the accuracy of the detection. Furthermore, this method cannot detect a motion of an object moving in a zigzag direction. This is because the method has only the reference of continuity of the direction of movement. Accordingly, whenever the direction of motion of an object changes, the continuity is initialized, and the change is not detected as motion.

Meanwhile, in U.S. Pat. No. 6,956,603, entitled, “Moving object detecting method, apparatus and computer program product”, by H. Fujii, a module which calculates an optical flow not in two continuous images, but in three continuous images, and detects an area having an error of an optical flow is added. Through this module, the accuracy of an optical flow is enhanced and the accuracy of detection of motion of an object is enhanced. However, the method has a problem of an increased amount of computation due to the added module.

Also, in U.S. Pat. No. 6,931,065, entitled, “Apparatus and method for motion detection of image in digital video recording system using MPEG video compression”, a technique using a motion vector of each block provided in a moving picture experts group (MPEG) compression method instead of an optical flow is disclosed. Since a given motion vector is directly used without separately calculating an optical flow, the method has an advantage of greatly reducing the amount of computation. However, since a motion vector is not provided in all frames of images, the number of frames in images to which this technique can be applied is limited. Also, this technique has an essential limitation that it cannot distinguish a motion sensitive to noise of an image and meaningful from a meaningless motion.

The motion detection technique based on an optical flow, described above, has a problem that the performance of detection varies greatly with respect to the accuracy of calculation of an optical flow, and the entire time taken for detecting a motion is longer due to the complicated calculation of an optical flow.

### SUMMARY

One or more embodiments of the present invention provide a method and apparatus for detecting a meaningful motion having a high accuracy with a small amount of required computation, by which a difference image between one frame and the next frame in an image is analyzed, and only a meaningful motion of an object in the image in which a meaningless motion is removed can be detected.

One or more embodiments of the present invention also provides an alarm apparatus, a frame output apparatus, an image compression apparatus, and an image processing apparatus using the detection of the meaningful motion.

Additional aspects and/or advantages will be set forth in part in the description which follows and, in part, will be apparent from the description, or may be learned by practice of the invention.

According to an aspect of the present invention, there is provided a method of detecting a meaningful motion, including generating a difference image including a plurality of regions each having a sign according to a motion of an input image from a plurality of input images, and by calculating the amount of motion in the difference image based on the sign of each of the regions of the difference image, detecting a meaningful motion of the input image.

According to another aspect of the present invention, there is provided an apparatus for detecting a meaningful motion, including a difference image calculation unit generating a difference image including a plurality of regions each having a sign according to a motion of an input image from a plurality of input images, and a motion detection unit detecting a meaningful motion of the input image, by calculating the amount of a motion in the difference image based on the sign of each of the regions of the difference image.

According to another aspect of the present invention, there is provided an alarm apparatus using a meaningful motion, including a meaningful motion detection apparatus generating a difference image including a plurality of regions each having a sign according to a motion of an input image from a plurality of input images, and by calculating the amount of motion in the difference image based on the sign of each of the regions of the difference image, detecting a meaningful motion of the input image, and an alarm generation unit comparing the value of the detected meaningful motion with a predetermined threshold value, and if the value of the meaningful motion is greater than the threshold value, generating an alarm signal.

According to another aspect of the present invention, there is provided a frame output apparatus using a meaningful motion, including a meaningful motion detection apparatus generating a difference image including a plurality of regions each having a sign according to a motion of an input image from a plurality of input images, and by calculating the amount of motion in the difference image based on the sign of each of the regions of the difference image, detecting a meaningful motion of the input image, and a frame selection unit comparing the value of the detected meaningful motion with a predetermined threshold value, and if the value of the meaningful motion is greater than the threshold value, outputting the input image.

According to another aspect of the present invention, there is provided an image compression apparatus using a meaningful motion, including a meaningful motion detection apparatus generating a difference image including a plurality of regions each having a sign according to a motion of an input image from a plurality of input images, and by calculating the amount of motion in the difference image based on the sign of each of the regions of the difference image, detecting a meaningful motion of the input image, a compression ratio calculation unit determining the compression ratio of the input image according to the value of the detected meaningful motion, and a compression unit compressing the input image according to the determined compression ratio and outputting the result.

According to another aspect of the present invention, there is provided an image processing apparatus using a meaningful motion, including a meaningful motion detection apparatus generating a difference image including a plurality of regions each having a sign according to a motion of an input image from a plurality of input images, and by calculating the amount of motion in the difference image based on the sign of each of the regions of the difference image, detecting a meaningful motion of the input image, and an image processing unit selectively processing the picture quality of the input image according to the value of the detected meaningful motion.

According to still another aspect of the present invention, there is provided a computer readable recording medium having embodied thereon a computer program for executing the methods.

Detailed and improved items of embodiments of the present invention are set forth in dependent claims.

### BRIEF DESCRIPTION OF THE DRAWINGS

These and/or other aspects and advantages will become apparent and more readily appreciated from the following description of embodiments, taken in conjunction with the accompanying drawings of which:

FIG. 1 is a schematic block diagram illustrating a conventional motion detection apparatus;

FIG. 2 is a schematic block diagram illustrating an apparatus for detecting a meaningful motion, according to an embodiment of the present invention;

FIG. 3 is a schematic block diagram of a difference image calculation unit of the apparatus illustrated in FIG. 2 according to an embodiment of the present invention;

FIG. 4 is a diagram illustrating a difference image considering a sign according to an embodiment of the present invention;

FIG. 5 is a graph for explaining a transportation problem according to an embodiment of the present invention;

FIG. 6 is a flowchart illustrating a method of generating a graph, according to an embodiment of the present invention;

FIG. 7 is a flowchart illustrating a method of calculating a minimum cost, according to an embodiment of the present invention;

FIG. 8 is a schematic block diagram of an alarm apparatus using a meaningful motion, according to an embodiment of the present invention;

FIG. 9 is a schematic block diagram of an apparatus for outputting a frame using a meaningful motion, according to an embodiment of the present invention;

FIG. 10 is a schematic block diagram of an apparatus for compressing an image using a meaningful motion, according to an embodiment of the present invention; and

FIG. 11 is a schematic block diagram of an apparatus for processing an image using a meaningful motion, according to an embodiment of the present invention.

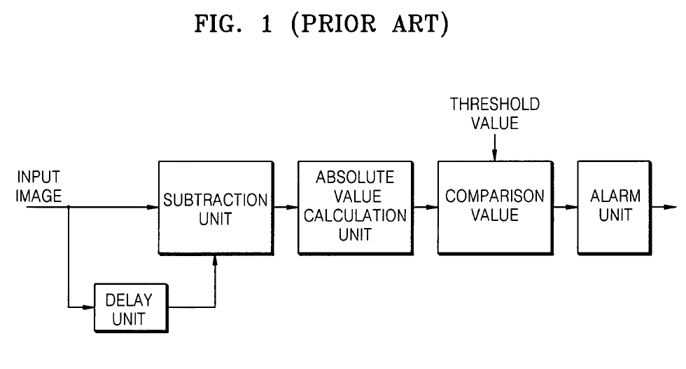

### DETAILED DESCRIPTION OF EMBODIMENTS

Reference will now be made in detail to embodiments, examples of which are illustrated in the accompanying drawings, wherein like reference numerals refer to like elements throughout. In this regard, embodiments of the present invention may be embodied in many different forms and should not be construed as being limited to embodiments set forth herein. Accordingly, embodiments are merely described below, by referring to the figures, to explain aspects of the present invention.

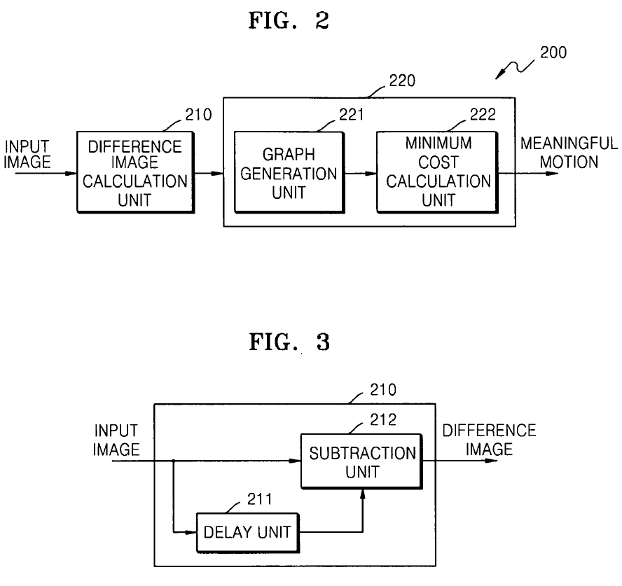

FIG. 2 is a schematic block diagram illustrating an apparatus 200 for detecting a meaningful motion, according to an embodiment of the present invention. Herein, in the present application the term apparatus should be considered synonymous with the term system, and not limited to a single enclosure or all described elements embodied in single respective enclosures in all embodiments, but rather, depending on embodiment, is open to being embodied together or separately in differing enclosures and/or locations through differing elements, e.g., a respective apparatus/system could be a single processing element or implemented through a distributed network, noting that additional and alternative embodiments are equally available.

Referring to FIG. 2, the apparatus 200 for detecting a meaningful motion according to the current embodiment of the present invention includes a difference image calculation unit 210, and a motion detection unit 220. The motion detection unit 220 may include a graph generation unit 221 and a minimum cost calculation unit 222.

The difference image calculation unit 210 generates a difference image including a plurality of regions each having a sign according to a motion of an input image from a plurality of input images. In this case, the input images indicate two or more continuous frames, and the difference image indicates the difference between a current frame and the next frame. The difference image calculation unit 210 and the difference image will be explained later in more detail with reference to FIG. 3.

The motion detection unit 220 receives the difference image having a sign from the difference image calculation unit 210, and calculates the amount of motion in the difference image based on the sign of each of the regions of the difference image, thereby detecting a meaningful motion from motion existing in the input image. That is, in the input image, only an object or a meaningful motion is detected. For example, repetitive and small motion such as that of leaves or ripples is removed and only a significant and clear motion is detected.

According to the current embodiment, the motion detection unit 220 includes the graph generation unit 221 and the minimum cost calculation unit 222.

The graph generation unit 221 generates and outputs a graph of nodes, including the sign and coordinate information of each of the regions in the difference image. The signs of the values of the regions of the difference image are determined, nodes having different attributes according to the signs are generated, and added to the graph. That is, based on the signal generated in the difference image calculation unit 210 according to the motion of the input image, nodes are set and the costs between nodes are set, thereby generating the graph. For example, in relation to a region in which the sign of the difference image is positive, a supplier node having the difference value as its capacity is set. In relation to a region in which the sign of the difference image is negative, a consumer node having the difference value as its capacity is set. Also, the cost between a supplier node x and a consumer node y is set in which the distance between x and y in the image is set as the cost. A Euclidian distance may be used for the distance.

The minimum cost calculation unit 222 calculates a minimum value of the total cost based on the node and cost information from the graph generation unit 221, thereby detecting a meaningful motion.

The motion detection unit 220 generates a graph of nodes from a difference image and calculates a minimum cost. That is, by considering the sign of each region of a difference image and the coordinates thereof, the amount of motion of an input image can be calculated, thereby detecting a meaningful motion in an input image.

FIG. 3 is a schematic block diagram of the difference image calculation unit 210 of the apparatus 200 illustrated in FIG. 2 according to an embodiment of the present invention.

Referring to FIG. 3, the difference image calculation unit 210 according to the current embodiment of the present invention includes a delay unit 211 and a subtraction unit 212.

The delay unit 211 stores a previous image frame and the subtraction unit 212 subtracts the previous image frame from a current input image frame, and outputs the subtraction result.

When calculating a difference image, the difference image calculation unit 210 according to the current embodiment considers the sign of the difference image. According to the conventional method of calculating a difference image, the brightness difference between a current frame and the next frame is calculated and, then, by using the absolute value of the brightness difference, the difference image is calculated. Then, if the magnitude of this difference image is greater than a predetermined threshold, it is determined that a motion of an object exists. In the conventional technique, a covered region in which an object covers the background and an uncovered region in which the background newly appears as the object moves are distinguished and treated identically. However, in the present invention, when calculating the difference between a current frame and the next frame, the difference image calculation unit 210 according to the current embodiment considers and outputs a difference value and the sign of the difference value, thereby allowing information on a covered region and an uncovered region to be utilized.

By considering the sign, the following advantages can be obtained. First, even whether or not an object is covered and before-and-after relationships of an object can be considered. This is because a covered region and an uncovered region in a difference image generally have signs different from each other. Accordingly, by using different signs, loss of information on the before-and-after relationships of an object in a process of obtaining an absolute value in the calculation of a difference image can be avoided. Secondly, calculation and implementation are simple. By omitting a process of calculating an absolute value when a difference image is calculated, the calculation can be implemented more simply and easily.

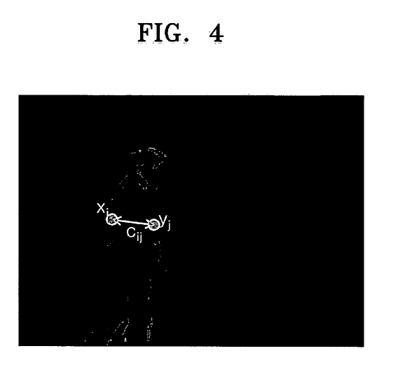

FIG. 4 is a diagram illustrating a difference image considering a sign according to an embodiment of the present invention.

Referring to FIG. 4, a difference image obtained by calculating the difference between two images is shown. Here, a covered region (yi) generated to the right of a person is separated from an uncovered region (xi) generated to the left of the person.

As illustrated in FIG. 4, as the person moves to the right, the uncovered region (xi) in which the background is newly appearing and the covered region (yi) in which the background is being covered, are shown. Also, a distance (cij) between the uncovered region (xi) and the covered region (yi) is shown.

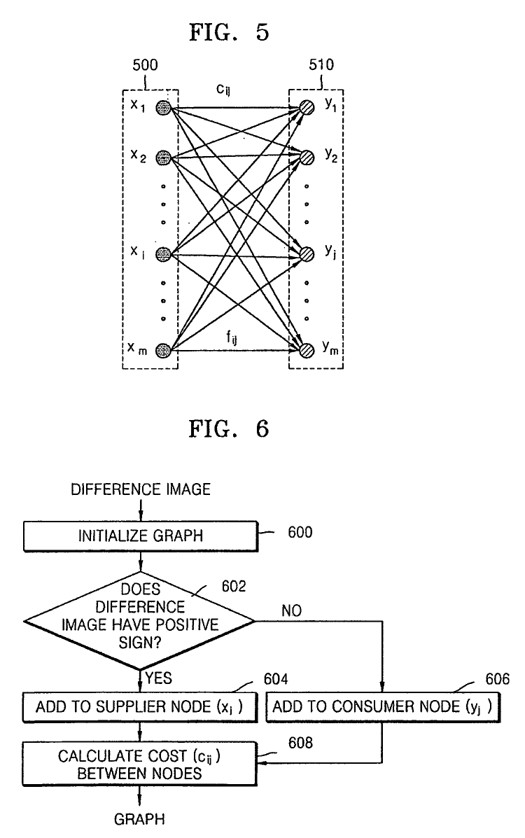

FIG. 5 is a graph of supplier nodes and consumer nodes, for explaining a transportation problem according to an embodiment of the present invention.

In order to measure the degree of a meaningful motion from a difference image considering a sign, a transportation problem is used. Here, as illustrated in FIG. 5, the transportation problem defines a graph G={X,Y} formed with a set X 500 of supplier nodes and a set Y 510 of consumer nodes.

For example, it is a problem of minimizing a moving cost when a product produced in a supplier node i of the set X 500 is moved to a consumer node j of the set Y 510 and consumed.

It is assumed that the amount of products produced in a supplier node i is xi, an accommodation capacity that can be consumed at a consumer node j is yj, and the cost when one unit of product is moved from a supplier node i to a consumer node j is cij. Also, it is assumed that the amount of products that are actually moved from the set X 500 of supplier nodes to the set Y 510 of consumer nodes is fij, the total cost obtained by adding all movements is obtained using the below Equation 1, for example.

$$total\_cost = {\sum }_{i = 1}^{m} {\sum }_{j = 1}^{n} {c}_{ij} {f}_{ij} \qquad Equation 1$$

Here, the transportation problem includes finding fij that minimizes the total cost when all products in the set X 500 of supplier nodes are moved or the accommodation capacities of all the consumer nodes of the set Y 510 are filled.

FIG. 6 is a flowchart illustrating a method of generating a graph of nodes, according to an embodiment of the present invention.

Referring to FIG. 6, the graph generation unit 221 illustrated in FIG. 2 initializes a graph so that the graph cannot have any nodes in operation 600.

In operation 602, the sign of the value of each of a plurality of regions of a difference image input from the difference image calculation unit 210 is determined

According to the sign, a region having a positive value of the difference image is added to the graph as a supplier node (xi) in operation 604. A region having a negative value of the difference image is added to the graph as a consumer node (yj) in operation 606. In operations 604 and 606, the capacity of each node is the value of the difference image, for example, the brightness of the difference image. In operation 608, the cost (cij) between each of the nodes is calculated. Here, the cost (cij) is defined as the distance between the corresponding regions in the difference image.

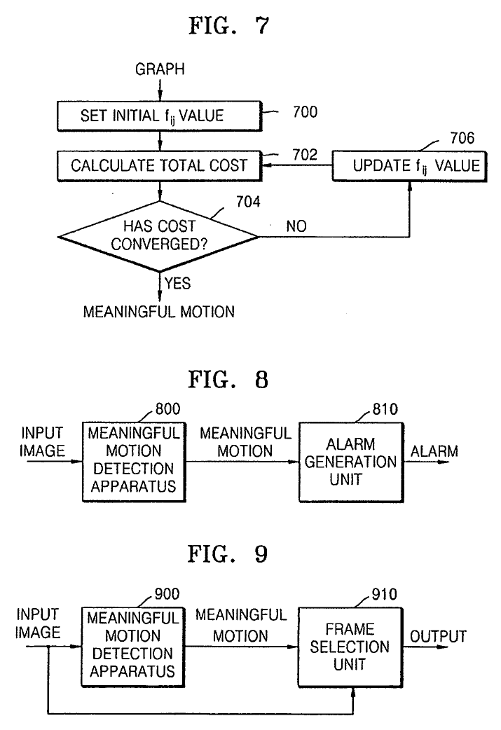

FIG. 7 is a flowchart illustrating a method of calculating a minimum cost, according to an embodiment of the present invention.

Referring to FIG. 7, the minimum cost calculation unit 222 receives an input of a graph as illustrated in FIG. 5 and sets an initial value fij in operation 700. In operation 702, a minimum total cost according to the set fij value is calculated. Here, the minimum total cost is calculated using the below Equation 2, for example.

$${cost}_{min} = min ( {\sum }_{i = 1}^{m} {\sum }_{j = 1}^{n} {c}_{ij} {f}_{ij} ) \\ w . r . t . {f}_{ij} \geq 0 , {\sum }_{j = 1}^{n} {f}_{ij} \leq {x}_{i} , {\sum }_{i = 1}^{m} {f}_{ij} \leq {y}_{i} , \\ {\sum }_{i = 1}^{m} {\sum }_{j = 1}^{n} {f}_{ij} = min ( {\sum }_{i = 1}^{m} {x}_{ij} , {\sum }_{j = 1}^{n} {y}_{ij} ) . \qquad Equation 2$$

Here, xi is the capacity of a supplier node i, yi is the capacity of a consumer node j, cij is the cost between node i and node j, and fij is an actually moved amount.

In operation 704, it is examined whether or not the calculated minimum total cost converges. If the minimum total cost converges, the minimum total cost is determined as a meaningful motion. If the minimum total cost does not converge, fij is updated in operation 706.

The above process is repeated until the total cost converges. For the calculation, a variety of known linear programming techniques can be used. For example, a simplex method may be used. A related optimization technique is disclosed in “Linear and Nonlinear Programming”, by Luenberg, 1984, Addison-Wesley.

The apparatus 200 for detecting a meaningful motion illustrated in FIG. 2 can be applied to a variety of image devices as described below and utilized.

First, the apparatus 200 can be used in detecting motion in an image in an image security system. In particular, if the suggested method is used, it can be used together with an image pickup apparatus, for example, a camera, in order to trigger an alarm. Also, the apparatus 200 can be used so that only when a meaningful motion occurs, an image can be selectively transmitted or stored. Also, if the apparatus 200 is used together with an image storage apparatus, for example, a DVR, the apparatus 200 can be used so that when a meaningful motion exists in a huge amount of image data, an image can be selectively transmitted or stored.

Secondly, the apparatus 200 can be used in a compression apparatus for other image transmission and storage apparatuses, and a compression technique can be discriminatively applied by distinguishing a meaningful motion from an unnecessary motion.

Thirdly, the apparatus 200 can be used in an image output apparatus, and can be used as a reference for selecting a variety of techniques for improving picture quality, thereby providing an improved picture quality image to users.

FIG. 8 is a schematic block diagram of an alarm apparatus using a meaningful motion, according to an embodiment of the present invention.

Referring to FIG. 8, the alarm apparatus using a meaningful motion according to the current embodiment of the present invention includes a meaningful motion detection apparatus 800 and an alarm generation unit 810.

The meaningful motion detection apparatus 800 calculates a difference image including a plurality of regions each having a sign from an input image, and based on the sign of each of the regions of the difference image, calculates the amount of motion in the difference image, thereby detecting only a meaningful motion of the input image.

When the value of the detected meaningful motion is greater than a predetermined threshold value, the alarm generation unit 810 generates and outputs an alarm.

The alarm apparatus according to the current embodiment can generate an alarm only when a meaningful motion exists in an input image. Through this, the detection ratio of a meaningful motion of an object can be maintained while lowering a false alarm ratio.

FIG. 9 is a schematic block diagram of an apparatus for outputting a frame using a meaningful motion, according to an embodiment of the present invention.

Referring to FIG. 9, the frame output apparatus using a meaningful motion according to the current embodiment of the present invention includes a meaningful motion detection apparatus 900 and a frame selection unit 910.

The meaningful motion detection unit 900 detects a meaningful motion as described above.

If the detected meaningful motion is greater than a predetermined threshold value, the frame selection unit 910 outputs an input image, and if the detected meaningful motion is equal to or less than the predetermined threshold value, the frame selection unit 910 does not output an input image.

The frame output apparatus according to the current embodiment can select and output only a frame having a meaningful motion in an input image. Through this, only a scene having a meaningful motion of an object can be transmitted or stored.

FIG. 10 is a schematic block diagram of an apparatus for compressing an image using a meaningful motion, according to an embodiment of the present invention.

Referring to FIG. 10, the image compression apparatus according to the current embodiment of the present invention includes a meaningful motion detection apparatus 1000, a compression ratio calculation unit 1010, and an image compression unit 1020.

The meaningful motion detection apparatus 1000 detects only a meaningful motion from an input image as described above.

If the value of the detected meaningful motion is high the compression ratio calculation unit 1010 reduces the compression ratio, and if the value of the detected meaningful motion is low, the compression ratio calculation unit 1010 increases the compression ratio.

The image compression unit 1020 compresses an input image according to the compression ratio calculated in the compression ratio calculation unit 1010, and outputs the result. That is, if the value of the meaningful motion is high, it indicates a meaningful motion of an object. Accordingly, by reducing the image compression ratio, an image is output as close to the original image as possible, thereby providing a more natural image result.

The image compression apparatus according to the current embodiment detects a meaningful motion in an image and adjusts an image compression ratio based on the detected meaningful motion. In this way, compression based on the content of an image can be performed.

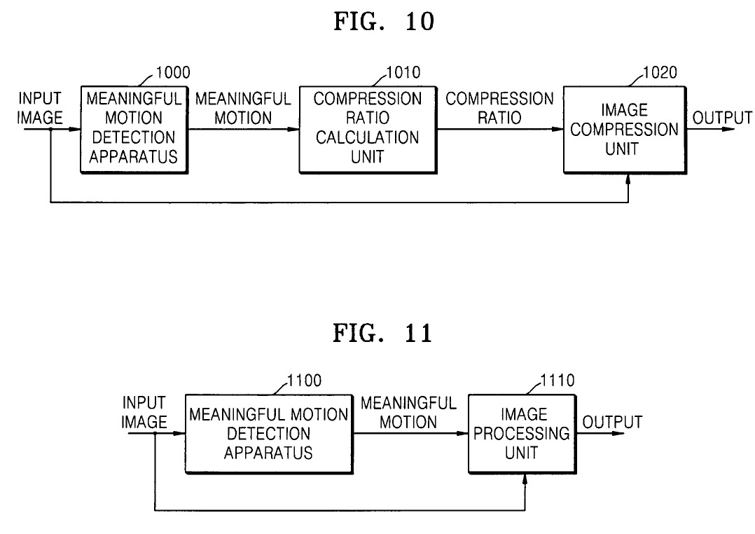

FIG. 11 is a schematic block diagram of an apparatus for processing an image using a meaningful motion, according to an embodiment of the present invention.

Referring to FIG. 11, the image processing apparatus according to the current embodiment of the present invention includes a meaningful motion detection apparatus 1100 and an image processing unit 1110.

The meaningful motion detection apparatus 1100 detects only a meaningful motion from an input image as described above.

According to the value of the detected meaningful motion, the image processing unit 1110 selectively applies and performs picture quality improvement processing. A proper picture quality improvement technique varies with respect to the characteristic of an input image. For example, for a static scene and a dynamic scene, different techniques should be used in order to output more natural images for a person to perceive. Accordingly, it is determined whether an image is static or dynamic, and then, according to the determination result, a corresponding processing is performed. That is, if the value of a meaningful motion is high, the image processing unit 1110 uses a dynamic image picture quality improvement technique, and if the value of a meaningful motion is low, the image processing unit 1110 uses a static image picture quality improvement technique. Then, the results of the dynamic and static image picture quality improvement techniques are synthesized and output.

The image processing apparatus according to the current embodiment detects a characteristic, i.e., a meaningful motion, of an input image, and performs image picture quality improvement processing according to this. In this way, the improvement of a stereo effect or picture quality of an image can be effectively performed.

According to the present invention as described above, a difference image including a plurality of regions each having a sign according to a motion of an input image from a plurality of input images is generated, and by calculating the amount of motion in the difference image based on the sign of each of the regions of the difference image, a meaningful motion of the input image is detected. In this way, a high detection ratio can be maintained, while a false alarm ratio with regard to meaningless motion can be lowered.

Furthermore, since a meaningful motion can be detected directly from a difference image, a complicated and time-consuming process of calculating an absolute value or an optical flow is not necessary, and a more accurate detection result can be obtained in a shorter time by performing the method of the present invention.

In addition to the above described embodiments, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as media carrying or including carrier waves, as well as elements of the Internet, for example. Thus, the medium may be such a defined and measurable structure including or carrying a signal or information, such as a device carrying a bitstream, for example, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

While aspects of the present invention has been particularly shown and described with reference to differing embodiments thereof, it should be understood that these exemplary embodiments should be considered in a descriptive sense only and not for purposes of limitation. Descriptions of features or aspects within each embodiment should typically be considered as available for other similar features or aspects in the remaining embodiments.

Thus, although a few embodiments have been shown and described, it would be appreciated by those skilled in the art that changes may be made in these embodiments without departing from the principles and spirit of the invention, the scope of which is defined in the claims and their equivalents.

What is claimed is:

1. A method of detecting a meaningful motion, comprising:
generating a difference image comprising a plurality of regions each having a sign according to a motion of an input image from a plurality of input images; and
detecting a meaningful motion of the input image through calculating an amount of motion in the difference image based on the respective sign of each of the regions of the difference image.

2. The method of claim 1, wherein the detecting of the meaningful motion of the input image comprises:
setting two types of nodes, for each region, based on the respective sign of each of the regions of the difference image, setting respective costs between each of the types of nodes, and thereby generating a graph representing the nodes and costs, and
calculating a minimum value of a total cost based on the nodes and costs represented by the generated graph to detect the meaningful motion.

3. The method of claim 2, wherein the setting of the two types of nodes comprises setting a different node according to the respective sign of the difference image.

4. The method of claim 3, wherein the respective costs between each of the nodes comprise respective distances between each of the two types of nodes.

5. The method of claim 2, wherein the minimum value is calculated using the following equation:
$${cost}_{min} = min ( {\sum }_{i = 1}^{m} {\sum }_{j = 1}^{n} {c}_{ij} {f}_{ij} )$$
$$w . r . t . {f}_{ij} \geq 0 , {\sum }_{j = 1}^{n} {f}_{ij} \leq {x}_{i} , {\sum }_{i = 1}^{m} {f}_{ij} \leq {y}_{i} , \\ {\sum }_{i = 1}^{m} {\sum }_{j = 1}^{n} {f}_{ij} = min ( {\sum }_{i = 1}^{m} {x}_{ij} , {\sum }_{j = 1}^{n} {y}_{ij} ) .$$
where, xᵢ is a capacity of a supplier node i, yᵢ is a capacity of a consumer node j, cᵢⱼ is a distance between the supplier node i and the consumer node j, that is, a corresponding cost, and fᵢⱼ is an actually moved amount.

6. The method of claim 1, wherein the generating of the difference image comprises:
storing a previous input image frame; and
subtracting the stored previous image frame from a current input image frame to generate the difference image.

7. The method of claim 1, wherein the difference image comprises an uncovered region and a covered region according to the motion of the input image.

8. A computer readable recording medium having embodied thereon a computer program to control a computer for executing the method of claim 1.

9. An apparatus for detecting a meaningful motion, comprising:
a difference image calculation unit generating a difference image comprising a plurality of regions each having a sign according to a motion of an input image from a plurality of input images; and
a motion detection unit detecting a meaningful motion of the input image through calculating an amount of motion in the difference image based on the respective sign of each of the regions of the difference image.

10. The apparatus of claim 9, wherein the motion detection unit comprises:
a graph generation unit setting two types of nodes, for each region, based on the respective sign of each of the regions of the difference image, setting respective costs between each of the two types of nodes, and thereby generating a graph representing the nodes and the costs; and
a minimum cost calculation unit detecting the meaningful motion through calculating a minimum value of a total cost based on the nodes and costs of the generated graph.

11. The apparatus of claim 10, wherein the setting of the two types of nodes comprises setting a different node according to the respective sign of the difference image.

12. The apparatus of claim 11, wherein the respective costs between each of the nodes comprises distances between each of the two types of nodes.

13. The apparatus of claim 9, wherein the difference image calculation unit comprises:
a storage unit storing a previous input image frame; and
a subtraction unit subtracting the stored previous image frame from a current input image frame to generate the difference image.

14. The apparatus of claim 9, wherein the difference image comprises an uncovered region and a covered region according to the motion of the input image.
